(19) United States
(12) Patent Application Publication
(10) Pub. No.: US 2024/0209602 A1
(43) Pub. Date: Jun. 27, 2024

(54) DEVICE FOR SELECTING A FLOW PATH OF A LIQUID OF A SANITARY SHOWER SET

(71) Applicant: Grohe AG, Hemer (DE)

(72) Inventors: Torsten MEIER, Duesseldorf (DE); Hartwig PHILIPPS, Menden (DE)

(73) Assignee: Grohe AG, Hemer (DE)

(21) Appl. No.: 18/562,993

(22) PCT Filed: May 31, 2022
(86) PCT No.: PCT/EP2022/064691

§ 371 Date: Nov. 21, 2023

(30) Foreign Application Priority Data
May 31, 2021 (DE) 10 2021 114 029.3

(51) Int. Cl. E03C 1/04

(52) U.S. Cl. CPC E03C 1/0405; E03C 1/0409; E03C 2201/30

(57) ABSTRACT

A device (1) for selecting a flow path (2) of a liquid of a sanitary shower set (3), having at least: a body (4) having at least one inflow (5) and a plurality of drains (6, 7, 8), wherein the drains (6, 7, 8) each have a drain inlet (9, 33, 34) having a seal (10, 38, 39) and wherein the seal (10, 38, 39) has at least one sealing lip (11); and a selector element (12) that rests against the sealing lips (11) and is mounted for rotation about an axis of rotation (13) for selecting the flow path (2).

This invention relates to a device for selecting a flow path of a liquid of a sanitary shower set. Such sanitary shower sets are used, in particular at sanitary faucets which provide a liquid on demand, for instance at showers, bathtubs, sinks or washbasins.

Sanitary shower sets for sanitary faucets are known, which are used to dispense a liquid, in particular water, in different types of spray patterns, for instance, full jets, massage jets, rain jets, etc. As a rule, the sanitary shower sets have different spray plates to form the different types of spray patterns. To form a specific type of spray pattern, the liquid has to be directed from an inflow of the sanitary shower set via a pipe system of the sanitary shower set to one of the spray plates of the sanitary shower set. For this purpose, valves are disposed in the piping. As a rule, high operating forces are required to operate the valves due to a liquid pressure of the liquid inside the sanitary shower sets. In addition, as a rule, the actuation forces are dependent on the liquid pressure of the liquid. This reduces the ease of use of the sanitary shower sets.

Therefore, the invention addresses the problem of solving at least part of the problems described with reference to the prior art and, in particular, of providing a device, which can be used to increase the ease of use of the sanitary shower sets.

This problem is solved by a device according to the features of the independent claim. Further advantageous embodiments of the device are specified in the dependent claims. It will be appreciated that the features listed individually in the dependent claims may be combined in any technologically useful manner and define further embodiments of the invention. In addition, the features indicated in the claims are further specified and explained in the description, wherein further preferred embodiments of the invention are illustrated.

A device for selecting the flow path of a liquid inside a sanitary shower set comprising at least the components listed below contributes to said object:
a body having at least one inflow and a plurality of drains, wherein the drains each comprise a drain inlet having a seal and wherein the seal comprises at least one sealing lip; and
a selector element that rests against the sealing lips and is mounted for rotation about an axis of rotation for selecting the flow path.

A hose and/or pipe, for instance, can be used to connect the sanitary shower set to a sanitary faucet. Sanitary faucets are used to provide a liquid on demand, in particular showers, bathtubs, sinks or washbasins. In particular, the device can be disposed at least partly in a sanitary shower set. The sanitary shower set can, for instance, be designed in the manner of a hand shower, an overhead shower or a shower head.

The device comprises a body having at least one inflow, which can be used to connect the device to a source of a liquid, for instance a sanitary faucet. The liquid flowing in via the at least one inflow can be routed to a plurality of drains through the body, which may be an (integrally formed or of multi-part design) plastic body-cast component, for instance. To do so, at least one flow path is formed inside the body, via which flow path the liquid can be routed from the inflow to the plurality of drains. For instance, the body may have two to six drains, preferably three drains. In particular, the individual drains can each lead to a spray plate for a specific type of spray pattern of the sanitary shower set. Thus, by selecting the flow path to a specific drain, a specific type of spray pattern of the sanitary shower set can be activated. Furthermore, the individual drains can be designed in the manner of a channel and each extend in the device from a drain inlet to a drain outlet. The individual drain inlets can be distributed, in particular evenly and/or circularly, around the axis of rotation of the selector element. For three drain inlets, for instance, these can be distributed offset by 120° around the axis of rotation of the selector element.

The device has a selector element for selecting the flow path. The selector element can be designed at least partly in the manner of a (substantially flat and/or circular) selector disk. Furthermore, the selector element, in particular one of its flat surfaces and/or an outflow end, can rest against a seal geometry. The seal geometry can, for instance, be a geometry of the body.

The drain inlets of the individual drains can be formed in the seal geometry and/or by the seal geometry. The liquid can enter the individual drains via the drain inlets. The drain inlets each comprise a seal having at least one sealing lip. The seal can be designed, in particular, in the manner of a lip seal. The seals or the at least one sealing lip can be at least partly made of an elastic material, such as rubber. The at least one sealing lip may extend at least partly in parallel, orthogonally, and/or obliquely to a central axis of the seal. For instance, the at least one sealing lip may extend at an angle of 20° to 70° with respect to the center axis. Furthermore, the at least one sealing lip can have a lip length of, for instance, 2 mm (millimeters) to 15 mm and/or a lip thickness of 0.5 mm to 5 mm. Furthermore, the seal may have a width of 2 mm to 20 mm in parallel to its center axis, for instance.

The selector element, in particular its outflow end, rests against the sealing lips and is mounted in the body such that it can rotate about an axis of rotation to select the flow path. In particular, the selector element can be rotated about the axis of rotation in such a way that an opening of the selector element is aligned with the drain inlet of the drain to be opened. In this way, the liquid can flow through the opening of the selector element into the respective drains. The drain inlets of those drains with which the opening of the selector element is not aligned are closed by contact of the selector element with the sealing lips of the seals, i.e., no liquid can flow into the respective drains. In particular, only one drain can be opened by the selector element, while the other drains are closed by the selector element.

The seals having the at least one sealing lip have the advantage that a high level of tightness can be achieved even at a low liquid pressure and/or a low contact pressure of the sealing lips against the selector element. Due to the lower contact pressure of the sealing lips compared to conventional seals, a lower torque is required for the rotation of the selector element, which increases the ease of use of the sanitary shower sets. Another advantage of seals having sealing lips compared to conventional seals having round or triangular cross sections is a reduced influence of manufacturing tolerances on the contact pressure of the seals, because these can be compensated by the flexibility of the sealing lips.

The seals can be annular in shape. For instance, the seals can each be designed in the form of a shaft seal ring or an axial shaft seal ring. Furthermore, the seals may have an inner diameter of 10 mm to 50 mm and/or an outer diameter of 12 mm to 52 mm.

The sealing lips can rest aslant against the selector element. In particular, the sealing lips can rest aslant against the outflow end of the selector element. This can mean, in particular, that the sealing lips do not lie flat against the selector element, but in particular a sealing surface rests against the latter in a linear or annular manner.

The sealing lips can each have a free space in which the sealing lips can be bent. The free space can, for instance, be designed in the manner of a (circumferential) undercut and/or in the manner of a (circumferential) groove. Furthermore, the free space can be formed in particular in a circumferential surface of the seal.

A cross-section of the seals may be at least partly V-shaped. In particular, this can also mean that the cross-section of the seals is not circular or triangular.

The sealing lips can be pressed against the selector element by the liquid. In particular, this can mean that the seal or sealing lips are disposed in such a way that they can be in contact with the liquid when the device is in use.

The seals may be disposed on a tubular section of the drains. In particular, the seals may be disposed on an outer circumferential surface of the tubular sections of the drains. The tubular sections of the drains may be designed in the manner of necks. Further, the tubular sections may each have a longitudinal end facing toward the selector element and/or contacting the outflow end of the selector element. The tubular sections of the drains are formed, in particular, in the area of the drain inlets. Furthermore, the tubular sections may extend at least partly in parallel to the axis of rotation of the selector element. The individual tubular sections can be distributed, in particular uniformly and/or circularly, about the axis of rotation of the selector element. For three tubular sections, for instance, these can be distributed offset by 120° about the axis of rotation of the selector element.

The seals can each be disposed in a receiving space, which is connected to the at least one inflow. In particular, the receiving spaces are connected to the at least one inflow in a liquid-conducting manner. In particular, this may mean that the liquid can flow from the at least one inflow into the receiving spaces when the device is in use. The receiving spaces of the individual seals can be interconnected (liquid-conducting). The receiving spaces are formed in particular in the body or in a lower segment of the body. Furthermore, the receiving spaces may be at least partly annular in shape.

The receiving spaces may be connected to the at least one inflow via at least one first gap between the body and a circumferential surface of the selector element. The at least one gap is in particular annular. The at least one first gap permits liquid to flow into the receiving spaces when the device is in use. In this case, the liquid flowing through the at least one first gap into the receiving spaces can press the sealing lips in particular against the selector element.

The receiving spaces may be connected to the drains via at least one second gap between a longitudinal end of the drains and an outflow end of the selector element. When the device is in use, liquid can flow through the at least one second gap into the receiving spaces, which liquid pressurizes the sealing lips, in particular from one end facing in the direction of the selector element. Alternatively, or additionally, the at least one opening of the selector element may be configured such that the liquid can flow into the receiving spaces via the at least one opening in any rotational position of the selector element when the device is in use. For this purpose, the at least one opening can, for instance, be designed as an elongated hole and/or have a diameter that is larger than an outer diameter of the tubular sections of the drains. This allows the liquid pressure of the liquid to act on both ends of the sealing lips, such that the liquid pressure has at least less of an effect on a torque required to rotate the selector element about the axis of rotation.

The invention and the technical environment are explained in more detail below with reference to the figures. It should be noted that the figures show particularly preferred variants of the embodiment of the invention, but the invention is not limited thereto. The same reference numerals are used for the same components in the figures. In an exemplary and schematic manner,

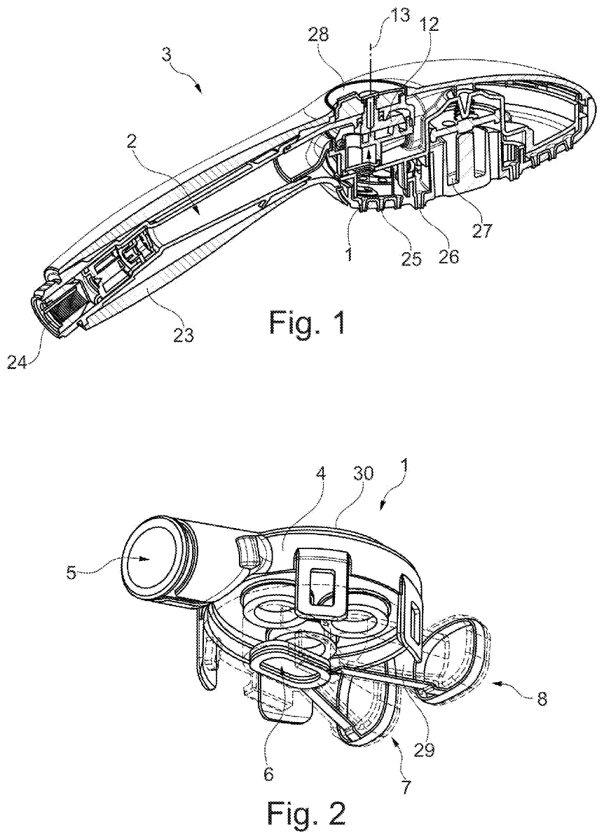

FIG. 1 shows a longitudinal cross-section of a sanitary shower set having a device for selecting a flow path;

FIG. 2 shows a perspective representation of the device;

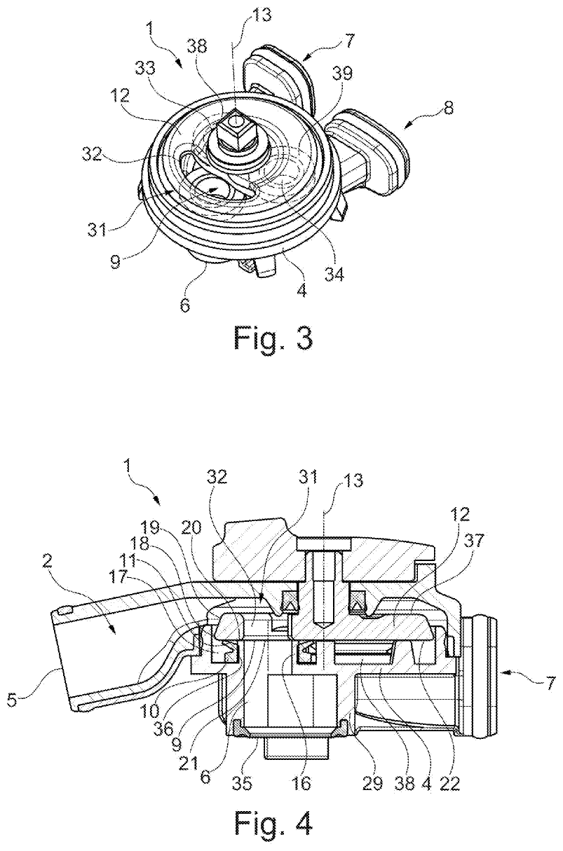

FIG. 3 shows a second perspective representation of the device;

FIG. 4 shows a longitudinal cross-section of the device having a first variant of the embodiment of a valve;

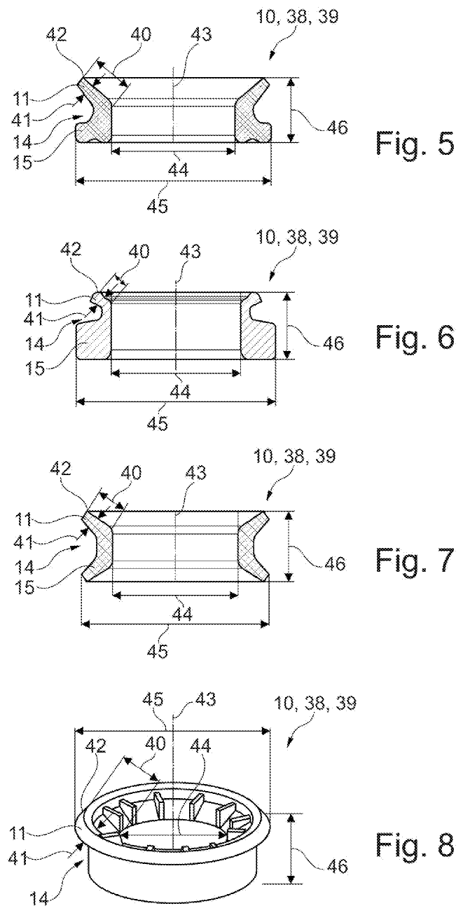

FIG. 5 shows a longitudinal cross-section of a second variant of the embodiment of the seal;

FIG. 6 shows a longitudinal cross-section of a third variant of the embodiment of the seal;

FIG. 7 shows a longitudinal cross-section of a fourth variant of the embodiment of the seal; and

FIG. 8 shows a perspective representation of the fifth variant of the embodiment of the seal.

FIG. 1 shows a perspective longitudinal cross-section of a sanitary shower set 3. The sanitary shower set 3 has a shower set body 23 having a liquid inlet 24, to which a liquid supply line or a liquid supply hose can be connected. A device 1 is disposed within the shower set body 23, which device is connected to the liquid inlet 24 via a flow path 2 in the form of a liquid channel, to route the liquid to the device 1. The device 1 can be used to select the flow path 2 in such a way that the liquid can optionally be routed to a first spray plate 25, to a second spray plate 26 or to a third spray plate 27, such that the liquid can be discharged through the sanitary shower set 3 in three different types of spray patterns. To select the flow path 2, the device 1 comprises a selector element 12 coupled to a rotating element 28, such that a user of the sanitary shower set 3 can rotate the selector element 12 about an axis of rotation 13 via the rotating element 28.

FIG. 2 shows a first perspective representation of the device 1. The device 1 has a body 4 having a lower segment of the body 29 (shown here as transparent) and an upper segment of the body 30 in the form of a body lid. The body 4 comprises an inflow 5 for supplying the liquid and a first drain 6 for routing the liquid to the first spray plate 25 shown in FIG. 1, a second drain 7 for routing the liquid to the second spray plate 26, and a third drain 8 for routing the liquid to the third spray plate 27.

FIG. 3 shows a perspective representation of the device 1. FIG. 3 does not show the upper segment of the body 30 shown in FIG. 2 to render the selector element 12 visible. The selector element 12 is shown transparent in FIG. 3 and is in a first switching position 31, in which an opening 32 of the selector element 12 is aligned with a first drain inlet 9 of the first drain 6 to open the first drain 6. The selector element 12 closes the second drain 7 and the third drain 8 in the first switching position 31. The second drain 7 has a second drain inlet 33 and the third drain 8 has a third drain inlet 34, which are concealed by the selector element 12 in FIG. 3. The drain inlets 9, 33, 34 are formed in the body 4 offset from each other by 120° about the axis of rotation 13. The selector element 12 can be rotated about the axis of rotation 13 to align the opening 32 of the selector element 12 with the second drain inlet 33 in a second switching position (not shown here) or with the second drain inlet 33 in a third switching position (not shown here). In the second switching position, the second drain 7 is open and the other drains 6, 8 are closed. Accordingly, in the third switching position, the third drain 8 is open and the other drains 6, 7 are closed.

FIG. 4 shows a longitudinal cross-section of the device 1. In FIG. 4, the first drain 6 can be seen extending from the first drain inlet 9 to a first drain outlet 35 of the lower segment of the body 29 of the body 4. The first drain 6 has a tubular section 16 in the area of the first drain inlet 9, against the longitudinal end 21 of which the outflow end 22 of the selector element 12 rests. A first variant of the embodiment of a first seal 10 is disposed on an outer circumferential surface 36 of the first tubular section 16, the first seal being annular in shape. A receiving space 17 for the first seal 10 is formed in the body 4. The first seal 10 has a sealing lip 11 that abuts the outflow end 22 of the selector element 12 at an angle, such that the first drain inlet 9 can be sealed tightly by the selector element 12 when the selector element 12 is not in the first switching position 31. During operation of the sanitary shower set 3 shown in FIG. 1, the liquid flows into the device 1 via the inflow 5 or the flow path 2, where it meets an influx end 37 of the selector element 12. In the first switching position 31 of the selector element 12 shown here, the liquid passes through the opening 32 of the selector element 12 and then flows through the first drain 6. The opening 32 extends from an influx end 37 of the selector element 12 in parallel to the axis of rotation 13 to the outflow end 22 of the selector element 12. In this case, the influx end 37 of the selector element 12 is subjected to a liquid pressure of the liquid across a larger area than the outflow end 22 of the selector element 12, such that the selector element 12 is pressed against the longitudinal end 21 of the first drain 6 and the sealing lip 11 of the first seal 10 by the liquid pressure of the liquid. The receiving space 17 of the first seal 10 is connected to the inflow 5 and/or the flow path 2 via a first gap 18 between the body 4 and a circumferential surface 19 of the selector element 12, such that the liquid enters the receiving space 17 through the first gap 18 and presses the sealing lip 11 of the first seal 10 against the outflow end 22 of the selector element 12. Furthermore, the receiving space 17 is connected to the first drain 6 via a second gap 20 between the longitudinal end 21 of the first drain 6 and the outflow end 22 of the selector element 12, such that the liquid can flow through a second gap 20 between the longitudinal end 21 of the first drain 6 and the outflow end 22 of the selector element 12 to the sealing lip 11 of the first seal 10 when the first drain 6 is open. In this way, the liquid pressure of the liquid can act on both ends of the sealing lip 11, reducing a contact pressure of the sealing lip 11 against the outflow end 22 of the selector element 12 and permitting the selector element 12 to be rotated about the axis of rotation 13 at a lower torque. The remaining drains 7, 8 are designed to match the first drain 6. In particular, the other drains 7, 8 have tubular sections 16 and seals 38, 39 (cf. FIG. 3), which are identical in design to those of the first seal 10.

FIGS. 5 to 8 show further variants of the embodiment of the seals 10, 38, 39. The seals 10, 38, 39 have a sealing lip 11 having a lip length 40 and a lip thickness 41. In addition, the seals 10, 38, 39 each have a V-shaped cross-section 15. On an end opposite from a sealing surface 42 of the sealing lips 11, the seals 10, 38, 39 have a free space 14 such that the sealing lips 11 can be bent into the free space 14 in parallel to a center axis 43. The seals 10, 38, 39 have an inner diameter 44, an outer diameter 45 and a width 46 in parallel to the center axis 43.

This invention can be used to improve the ease of use of a sanitary shower set.

### LIST OF REFERENCE NUMERALS AND TERMS

1 device
2 flow path
3 sanitary shower set
4 body
5 inflow
6 first drain
7 second drain
8 third drain
9 first drain inlet
10 first seal
11 sealing lip
12 selector element
13 axis of rotation
14 free space
15 cross-section
16 tubular section
17 receiving space
18 first gap
19 circumferential surface
20 second gap
21 longitudinal end
22 outflow end
23 shower body
24 liquid inlet
25 first spray plate
26 second spray plate
27 third spray plate
28 rotary element
29 lower segment of the body
30 upper segment of the body
31 first switching position
32 opening
33 second drain inlet
34 third drain inlet
35 first drain outlet
36 outer circumferential surface
37 influx end
38 second seal
39 third seal
40 lip length
41 lip thickness
42 sealing surface
43 center axis
44 inner diameter
45 outer diameter
46 width

1. A device (1) for selecting a flow path (2) of a liquid of a sanitary shower set (3), comprising at least:
a body (4) having at least one inflow (5) and a plurality of drains (6, 7, 8), wherein the drains (6, 7, 8) each comprise a drain inlet (9, 33, 34) having a seal (10, 38, 39) and wherein the seal (10, 38, 39) comprises at least one sealing lip (11); and
a selector element (12) that rests against the sealing lips (11) and is mounted for rotation about an axis of rotation (13) for selecting the flow path (2).

2. The device (1) according to claim 1, wherein the seals (10, 38, 39) can be annular in shape.

3. The device (1) according to claim 1, wherein the sealing lips (11) rest aslant against the selector element (12).

4. The device (1) according to claim 1, wherein the sealing lips (10, 38, 39) can each have a free space (14), in which the sealing lips (11) can be bent.

5. The device (1) according to claim 1, wherein a cross-section (15) of the seals (10, 38, 39) is at least partly V-shaped.

6. The device (1) according to claim 1, wherein the liquid can press the sealing lips (11) against the selector element (12).

7. The device (1) according to claim 1, wherein the seals (10, 38, 39) are disposed on a tubular section (16) of the drains (6, 7, 8).

8. The device (1) according to claim 1, wherein the seals (10, 38, 39) are each disposed in a receiving space (17), which is connected to the at least one inflow (5).

9. The device (1) according to claim 8, wherein the receiving spaces (17) are connected to the at least one inflow (5) via at least one first gap (18) between the body (4) and a circumferential surface (19) of the selector element (12).

10. The device (1) according to claim 8, wherein the receiving spaces (17) are connected to the drains (6, 7, 8) via at least one second gap (20) between a longitudinal end (21) of the drains (6, 7, 8) and an outflow end (22) of the selector element (12).
